(19) United States
(12) Patent Application Publication
(10) Pub. No.: US 2011/0213568 A1
(43) Pub. Date: Sep. 1, 2011

(54) METHODS AND SYSTEMS FOR ASSESSING GENERATOR ROTORS

(75) Inventors: Yogesh Kesrinath Potdar, Niskayuna, NY (US); Robert Martin Roney, JR., Schoharie, NY (US); Paul Clinton Bagley, Middleburgh, NY (US); Shantanu Madhavrao Sane, Niskayuna, NY (US); Umit Ozkan, Clifton Park, NY (US)

(73) Assignee: GENERAL ELECTRIC COMPANY, SCHENECTADY, NY (US)

(21) Appl. No.: 12/714,138

(22) Filed: Feb. 26, 2010

(51) Int. Cl. G06F 19/00

(52) U.S. Cl. 702/34

(57) ABSTRACT

Methods, systems and computer program products for assessment of a generator rotor are provided. A method includes receiving crack data for the generator rotor from at least one inspection; computing a crack propagation rate based on the crack data and at least one parameter, wherein the at least one parameter comprises an operating condition of the generator rotor or a design parameter of the generator rotor; and providing at least one recommendation associated with the generator rotor based on the computed crack propagation rate.

### BACKGROUND OF THE INVENTION

1. Field of the Invention

The present invention relates to a generator rotor and specifically, to a method and a system for providing one or more recommendations associated with residual life, inspection intervals and maintenance of the generator rotor.

2. Description of the Related Art

Electric generators are well known in the art and are extensively used in the power generation industry to convert mechanical energy into electrical energy. Typically, an electric generator used in a power generation system includes a generator rotor (or field) that is rotatably aligned about an axis of rotation. The generator rotor includes multiple longitudinal slots disposed in the axial direction and coils placed within each longitudinal slot. Under normal operating conditions, when the generator rotor is rotating, a centrifugal force may act on the coils. In order to tightly hold the coils within the longitudinal slots, fitted structure type rotors are used. A fitted structure type rotor may include dovetails on the outer periphery of the longitudinal slots and wedges inserted within the dovetails.

The contact areas between the dovetails and the wedges can experience relative movement resulting in damage accumulation and crack initiation at or near contact regions experiencing relative motion. This is commonly known as fretting. In due course of time, generator rotors may develop cracks at dovetails and other critical areas that may undergo fretting fatigue, high stress concentration and mechanical wear. Moreover, fretting fatigue cracks may propagate and rapidly extend due to the high cycle fatigue accompanying rotation. The cracks at dovetails may be severe enough to lead to a fatigue failure of the generator rotor. Neglected fretting fatigue cracks in the generator rotor may lead to unplanned outages.

Various systems and methods have been proposed to detect and repair generator rotors in which the cracks are detected. Typically, various in-situ detection techniques, such as but not limited to, ultrasonic and optical methods are used to detect cracks in the generator rotor. Periodic inspections of the generator rotor are necessary for timely detection of the cracks. Further, crack data obtained from the in-situ detection techniques may be used with various statistical and probabilistic models for predicting a crack propagation rate. However in some cases the detected cracks are short and may not propagate as predicted by statistical methods.

Various other crack propagation rate prediction techniques are also known in the art. Known prediction techniques to predict crack propagation rates are based on observed crack data obtained by periodic inspections. Such methods use interpolation techniques based on observed data for obtaining expected future crack dimensions. Reliability of such methods is questionable as crack propagation depends on a multitude of factors such as, but not limited to, material properties, operating conditions, and current crack size. Interpolation of observed crack data, without taking other factors into account, for predicting expected future crack dimensions may not yield sufficiently accurate results. Further, most of these systems and methods provide recommendations to repair the generator rotor on detection of a crack or on prediction of the crack being propagated beyond an allowed limit.

The repairing of a generator rotor primarily involves removing rotor material from the cracked area (e.g. grinding or blending). This repairing technique is used irrespective of size and location of the detected crack. Such repairing techniques do not always yield the desired effect, as the cracks with a dimension larger than a critical dimension are generally beyond repair. Removal of material in the areas of larger cracks may also reduce the residual life of the generator rotor by reducing overall load carrying capacity of the rotor.

Thus, there is a need for an improved method and system which can maximize availability, maintain reliability, and provide a good forecast on upcoming repair or replacement requirements of a generator rotor.

### BRIEF DESCRIPTION OF THE INVENTION

The present invention provides a system and a method for assessment of a generator rotor, where inspected crack data and operating conditions of the generator are used to compute a crack propagation rate. Various embodiments of the present invention may use the computed crack propagation rate to provide various recommendations associated with the maintenance of the generator rotor.

In an embodiment of the present invention, a method for assessment of a generator rotor includes receiving crack data for a generator rotor from at least one inspection. The method also includes computing a crack propagation rate based on the crack data and at least one parameter, wherein the at least one parameter comprises an operating condition of the generator rotor or a design parameter of the generator rotor. Based on the computed crack propagation rate the method provides at least one recommendation associated with the generator rotor.

In another embodiment of the present invention, a system is provided for assessment of a generator rotor. The system includes a user interface to obtain crack data. The system includes a module to estimate the operating conditions of the generator rotor. The system also includes a computing module operable to compute a crack propagation rate based on the crack data and at least one parameter, wherein the at least one parameter comprises an operating condition of the generator rotor or a design parameter of the generator rotor. Further, a decision making module of the system is operable to provide at least one recommendation associated with the generator rotor based on the computed crack propagation rate.

In yet another embodiment of the present invention, a computer program code stored in a computer readable storage medium is provided. The computer program code, when executed, operates to cause one or more processors to receive crack data for a generator rotor from at least one inspection. The computer program code further causes the one or more processors to compute a crack propagation rate based on the crack data and at least one parameter, wherein the at least one parameter comprises an operating condition of the generator rotor or a design parameter of the generator rotor. The computer program code further causes the one or more processors to provide at least one recommendation associated with the generator rotor based on the computed crack propagation rate. In various embodiments, the computer program code is a non-transitory code.

These and other advantages and features will be more readily understood from the following detailed description of preferred embodiments of the invention that is provided in connection with the accompanying drawings.

### BRIEF DESCRIPTION OF DRAWINGS

FIG. 1 illustrates a cross section of a generator rotor of a type for use in an embodiment of the present invention.

FIG. 2 illustrates an example method for providing one or more recommendations based on an assessment of the generator rotor, according to an embodiment of the present invention.

FIG. 3 illustrates an exemplary plot of generator rotor crack size vs. number of generator shutdowns for use according to an embodiment of the present invention.

FIG. 4 illustrates an exemplary table representing stress intensity factor range, according to an embodiment of the present invention.

FIG. 5 illustrates an exemplary user interface 500 of a fretting fatigue model according to an embodiment of the present invention.

FIG. 6 illustrates a system for providing one or more recommendations based on an assessment of the generator rotor according to an embodiment of the present invention.

### DETAILED DESCRIPTION OF THE INVENTION

The present invention provides methods, systems and computer program products for making recommendations pertaining to the maintenance of a generator rotor that overcomes the aforementioned drawbacks. In one embodiment, the method employs physics based life assessment techniques for recommending maintenance actions and assessing the residual life of a generator rotor.

The generator is inspected to locate and obtain crack data for the generator rotor. Based on the crack data and at least one of an operating condition of the generator, a design parameter, a material property, a stress intensity factor range, a geometry of the generator rotor, and a shutdown profile of the generator rotor, a crack propagation rate is determined using a physics based life assessment technique. The crack propagation rate shows the propagation of cracks with successive shutdowns of the generator rotor. Based on crack propagation rate, recommendations pertaining to replacement or repairing requirements of the generator rotor are made.

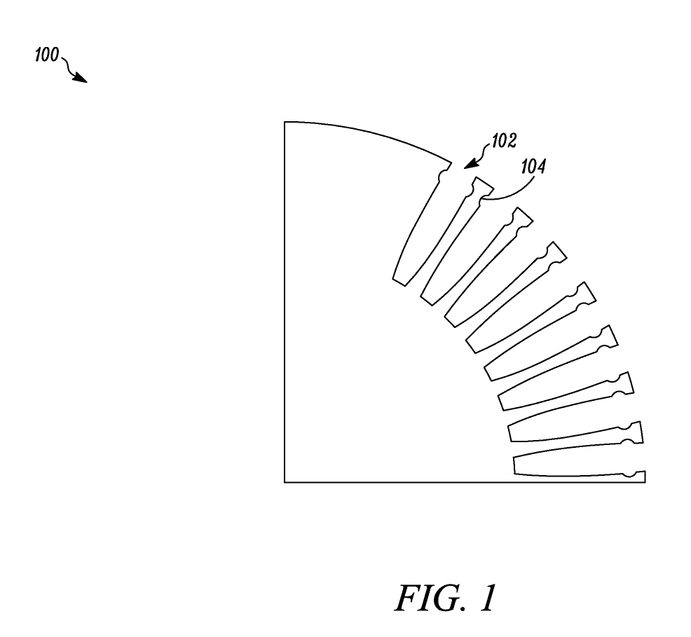

FIG. 1 illustrates a cross sectional view of a generator rotor 100 of an electrical generator (not shown). The generator rotor 100 has a plurality of slots 102 which extend axially along the length of the generator rotor 100. Conducting coils (not shown) are placed inside the plurality of slots 102. The generator rotor 100 also consists of a plurality of dovetails 104 disposed at an end of each slot 102. Under normal operation of the electrical generator, the coils inside the slots 102 are subjected to a centrifugal force. In order to prevent any dislocation of coils from the slots 102 due to the centrifugal force, wedges (not shown) are secured within pairs of the plurality of dovetails 104. During the operation of the generator, the contact area between dovetails 104 and wedges experiences relative movement and can result in fretting damage. In due course of time, generator rotor 100 develops cracks due to fretting fatigue. During start-ups and shutdowns of the electrical generator, these cracks may propagate and lead to a failure of the generator rotor 100. The propagation of cracks in the generator rotor 100 may depend on the geometry, material properties, and loading conditions of the generator rotor 100. If such cracks are not timely inspected and removed, unplanned shutdowns and power failures may result.

In one embodiment of the present invention, an ultrasonic inspection technique or an optical inspection technique may be used to detect a crack and obtain data relating to the crack. In alternative embodiments of the present invention, various in-situ inspection techniques may be used to detect the crack and obtain the crack data. In various other embodiments of the present invention, the inspection techniques may include any other known methods and systems to detect the crack and obtain the crack data. It is apparent to a person ordinarily skilled in the art that the exemplary embodiments of the inspection techniques described herein do not limit the scope of the present invention.

In an embodiment of the present invention, the crack data obtained by the inspection technique may be used to compute a crack propagation rate. Additional parameters, such as operating conditions of the generator rotor 100 and design parameters of the generator rotor 100 may be used along with the crack data to compute the crack propagation rate. In one embodiment of the present invention, the computed crack propagation rate may be used to provide one or more recommendations associated with the generator rotor 100. In an embodiment of the present invention, the recommendations may include, for example, inspection intervals and repair requirements of the generator rotor 100. In an embodiment of the present invention, the recommendations may include, for example, allowable start-ups for the generator rotor 100 without a major repair of the inspected crack.

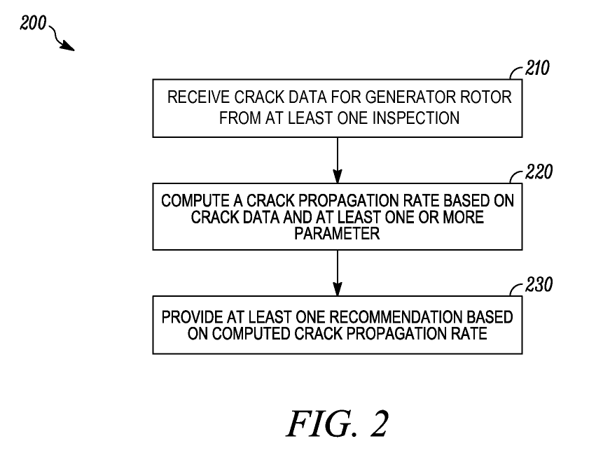

FIG. 2 illustrates a flow chart of a method 200 for providing the one or more recommendations in accordance with an embodiment of the present invention. In step 210 of method 200, a crack propagation rate computing module receives the crack data for the generator rotor 100. The crack data may be obtained by an inspection unit using one or more inspection techniques, as described above. In an embodiment of the present invention, the crack data may include crack depth and crack aspect ratio at the dovetail 104 of the generator rotor 100. In some embodiments, the computing module may recommend the performance of one or more inspections of the generator rotor 100, for providing the crack data. For example, the computing module may recommend the inspection of crack dimensions such as crack depth, crack ratio at the dovetail 104, and so forth. The computing module may also recommend the inspection of timelines such as number of operational hours, number of operational days, number of generator start-ups, number of generator shut-downs, and so forth.

In step 220 of method 200, the crack propagation rate may be computed based on the crack data and one or more parameters. The one or more parameters may include operating conditions and design parameters of the generator rotor 100. In an embodiment of the present invention, the operating conditions may include a current or an expected operating condition of the generator rotor 100 such as, for example, a rotational speed of the generator rotor 100, a power output of the generator rotor 100, and a number of start-ups or shutdowns of the generator rotor 100. In an embodiment of the present invention, the rotational speed of the generator rotor 100 may range up to 3600 RPM. In another embodiment of the present invention, the rotational speed of the generator rotor 100 may range up to 1800 RPM. In an embodiment of the present invention, the design parameters may include the geometry, loading, and/or boundary conditions of the generator rotor 100. The geometry of the generator rotor 100 may include data pertaining to, for example, mechanical design of the generator rotor 100. The data pertaining to the geometry of the generator rotor 100 may be obtained from an Original Equipment Manufacturer (OEM) for the electrical generator. In an embodiment of the present invention, the loading may include mean and alternating stresses due to rotational, thermal and frictional loads on the generator rotor 100. In an embodiment of the present invention, step 220 may include physics based life assessment techniques to compute the crack propagation rate based on the crack data and operating conditions for the generator rotor 100.

In an embodiment of the present invention, the physics based life assessment technique may include a 3D fracture mechanics based analysis. The 3D fracture mechanics based analysis may use the loading conditions, geometry of the generator rotor 100 and the crack data to compute a stress intensity factor range (ΔK) for a given crack size of the generator rotor 100. The stress intensity factor range (ΔK) is the difference between stress intensity factors (K) at maximum and minimum loading of the generator rotor 100 during a fatigue cycle. The stress intensity factor range (ΔK) may be used with a shutdown profile of the generator rotor 100, material property of the generator rotor 100, and/or geometry of the generator rotor 100 to compute the crack propagation rate. In various other embodiments of the present invention, step 220 may include physics based methods to predict crack propagation of small fretting cracks. Such physics based methods may take into account parameters such as structural loads, boundary conditions, material properties, and mechanics of crack growth in a generator rotor in which small cracks have been observed. Although specific methods for computing crack propagation rates have been described herein, it will be appreciated that other methods known in the art for computing the crack propagation rate may be used. In an embodiment of the present invention, the design parameters and the expected operating conditions may be used along with the operating conditions and the crack data to compute the crack propagation rate.

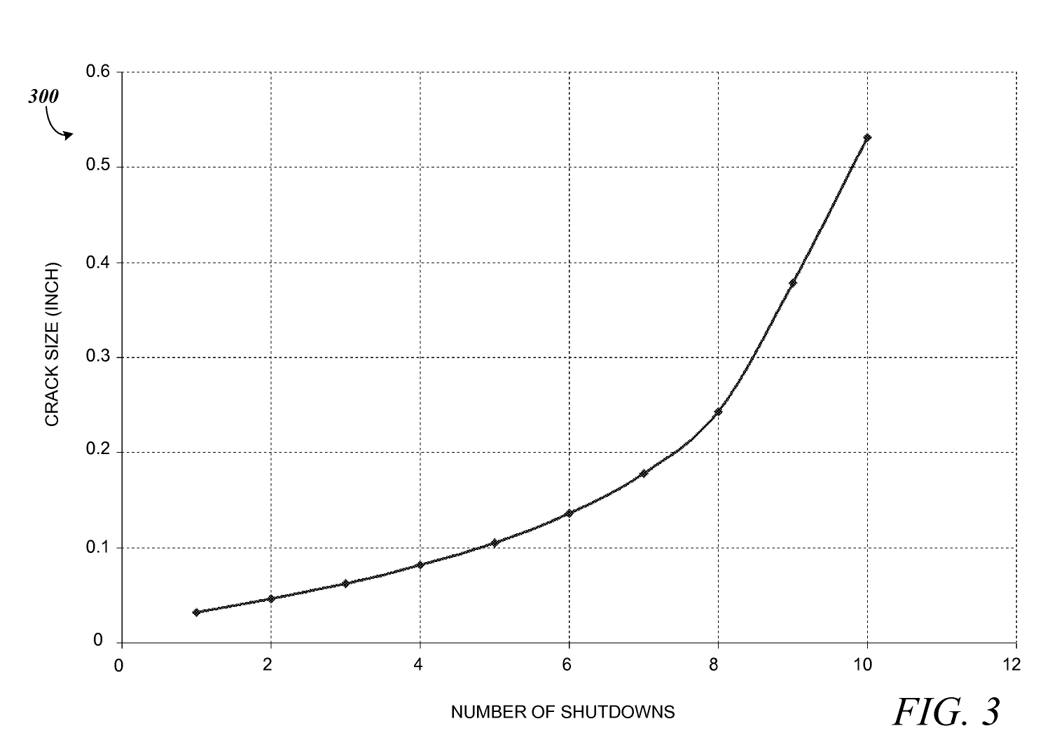

In an embodiment of the present invention, in step 220 a number of fatigue cycles accumulated by the generator rotor 100 during a shutdown cycle may be also a parameter used to compute the crack propagation rate. The number of fatigue cycles accumulated by the generator rotor 100 is based on the shutdown profile of the generator rotor 100. Further, based on the operating history of the generator rotor 100 and an expected operating condition of generator rotor 100, an expected pattern of shutdowns may be estimated. In an embodiment of the present invention, the crack propagation rate may be represented as a plot of crack size versus the number of shutdowns. An exemplary plot for the crack propagation rate is illustrated in FIG. 3.

In an embodiment of present invention, in step 230, method 200 may provide one or more recommendations based on the crack propagation rate which is computed in step 220. In an embodiment of the present invention, the recommendations may include a time interval for the inspection of the generator rotor 100. In another embodiment of the present invention, the recommendations may include advice on an allowable number of start-ups for the generator rotor 100 in a given time frame. In yet another embodiment of the present invention, the recommendations may include repair requirements for the generator rotor 100 such as, for example, removal of cracks or any other measures that need to be taken pertaining to the maintenance of the generator rotor 100. In an alternate embodiment of the present invention, a residual life of the generator rotor may be estimated based on the crack propagation rate and estimated number of shutdowns of the generator rotor 100. Recommendations pertaining to repair requirements of the generator rotor 100 may also include a suggested time frame or the number of shutdowns within which the inspected crack in the generator rotor 100 may not require repairs.

Timely recommendations pertaining to the generator rotor 100 may avoid any power outage and increase the availability and the reliability of a power generation system. Recommendations may also be helpful in making decisions pertaining to repair and replacement of the generator rotor 100, for example, a crack propagation rate obtained from method 200 may indicate an immediate repair or replacement requirement or suggest a number of shutdowns for the generator rotor 100. The repair of the cracks may also lead to increase in the residual life of the generator rotor 100.

FIG. 3 illustrates an exemplary plot 300 between the generator rotor crack size and a number of shutdowns, according to an embodiment of the present invention. In an embodiment of the present invention, the plot 300 may be obtained in step 220 of method 200. In an embodiment of the present invention, the plot 300 may be obtained by the physics based life assessment technique as described in step 220 of method 200. In an embodiment of the present invention, based on an initial crack data and at least one of the operating conditions and design parameters of the generator, the physics based life assessment technique may determine a final crack data during a shutdown cycle of the generator rotor 100. The final crack data after may be used as an input to a fretting fatigue model for the next shutdown cycle and hence, the exemplary plot 300 may be generated and updated.

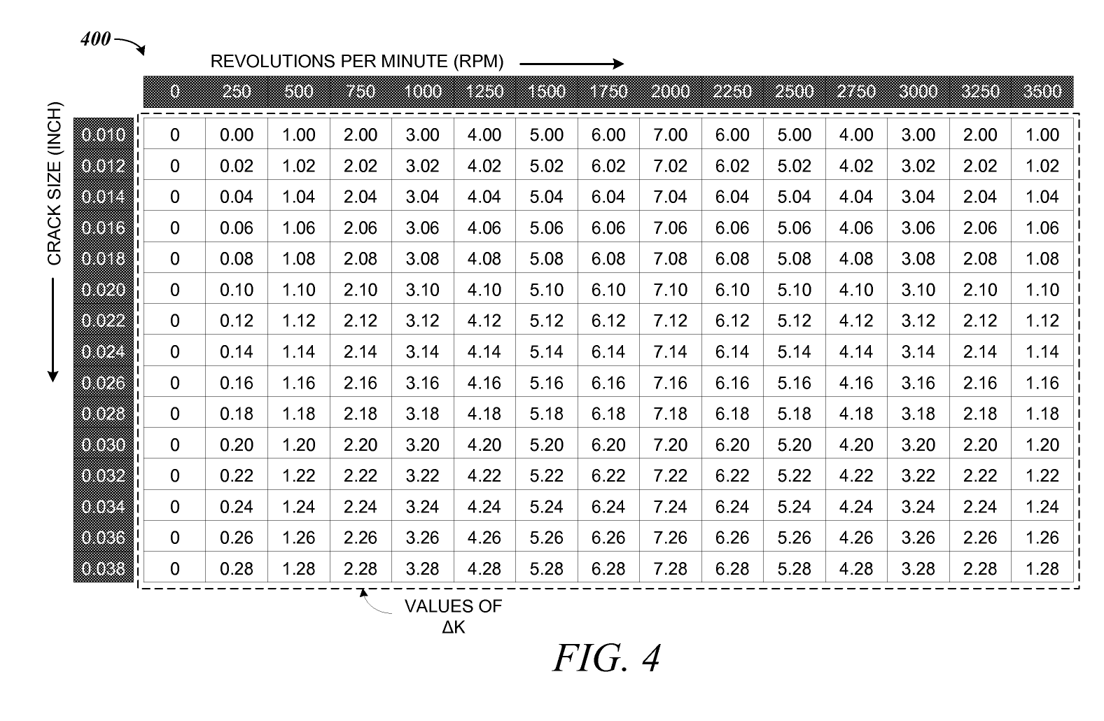

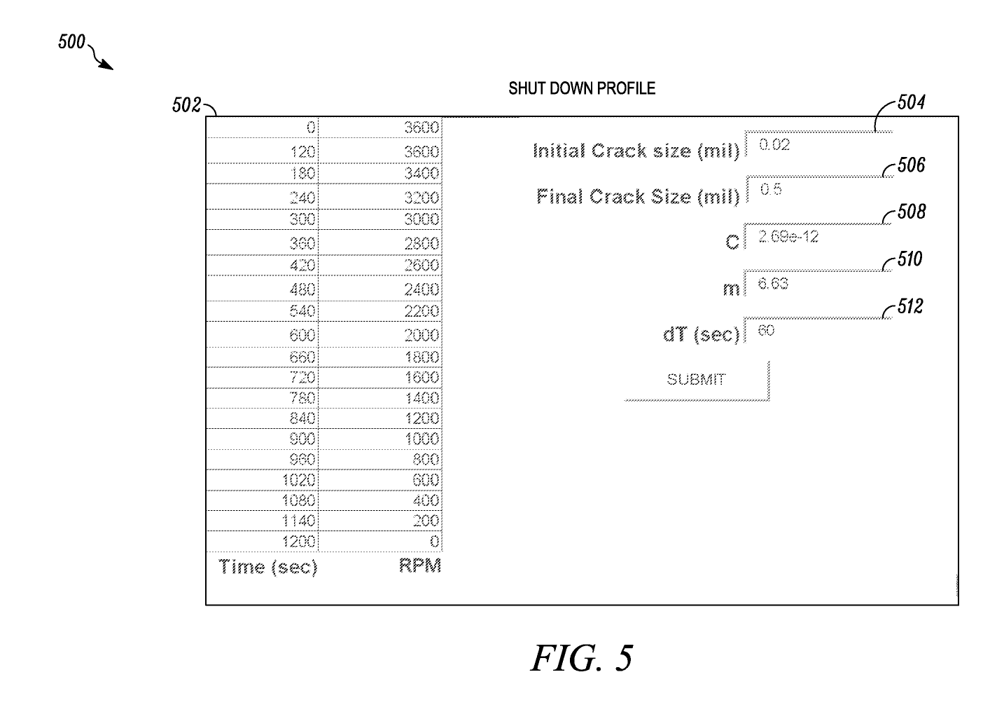

In an embodiment of the present invention, the fretting fatigue model may use Paris's law for fatigue crack growth. Paris's Law requires the current crack size, the stress intensity factor range (ΔK), the material property of the generator rotor 100, and the shutdown profile of the generator rotor 100 as inputs. The stress intensity factor range (ΔK) and the shutdown profile are explained in detail in conjunction with FIG. 4 and FIG. 5 respectively.

In an embodiment of the present invention, an initial crack size and the one or more parameters such as, for example, the stress intensity factor range (ΔK), the shutdown profile, and the design parameters of the generator rotor 100 may be used as an input to Paris's Law and a final crack size at the end of a shutdown cycle is obtained. The final crack size at the end of the shutdown cycle may be taken as the initial crack size for the next shutdown cycle and the process is repeated for obtaining the final crack size at the end of progressive shutdown cycles. Also, based on the operating history of the generator rotor 100, the number of shutdowns expected in a given timeframe may be estimated. Based on the number of expected shutdowns in the given timeframe, the plot 300 may be generated and used to predict the residual life of the generator rotor 100.

FIG. 4 illustrates an exemplary table 400 representing the stress intensity factor range (ΔK) according to an embodiment of the present invention. The exemplary table may include the stress intensity factor range (ΔK) data for various crack sizes and operating conditions of the generator rotor 100. In an embodiment of the present invention, the operating conditions of the generator rotor may include the rotational speed of the generator rotor 100. In an embodiment of the present invention, the stress intensity factor range (ΔK) data obtained for the exemplary table 400 may be used to compute the crack propagation rate. The stress intensity factor range (ΔK) for a given crack size and the rotational speed of the generator rotor 100 may be obtained from the exemplary table 400.

In an embodiment of the present invention, 3D fracture mechanics based stress analysis may be used to compute the stress intensity factor range (ΔK) for various rotational speeds of the generator rotor 100. In various other embodiments of the present invention, the exemplary table 400 may be compiled by any other known methods for stress analysis that account for structural loads and boundary conditions, material properties, and mechanics of crack growth. The table 400 may be generated and stored in a database. Alternatively, the table 400 may be generated on a real time basis based on databases of structural design parameters, known loads, material properties, operational history, and anticipated operation plans. As it will be apparent to a person skilled in the art, the exemplary values of the stress intensity factor range (ΔK) for a given generator rotor 100 may be a part of the data obtained from the Original Equipment Manufacturer (OEM) of the electrical generator.

FIG. 5 illustrates an exemplary user interface 500 of the fretting fatigue model according to one embodiment of the present invention. The exemplary user interface 500 may include a shutdown profile 502 for the generator rotor 100 in a tabulated form. The shutdown profile 502 of the generator rotor 100 shows the rotational speeds of the generator rotor 100 at various stages of the shutdown cycle. In an embodiment of the present invention, the shutdown profile 502 may include the rotational speeds of generator rotor 100 which slows down from 3600 RPM to 0 RPM in 1200 seconds. The shutdown profile 502 of the generator rotor 100 may be used to compute accumulated fatigue cycles in the shutdown cycle. The number of fatigue cycles accumulated during the shutdown cycle depends on the shutdown profile 502 of the generator rotor 100. In an embodiment of the present invention, based on the shutdown profile 502 and accumulated fatigue cycles, a computing module computes the crack growth during the shutdown cycle.

The user interface 500 also illustrates data boxes to enter data to the fretting fatigue model and to compute crack growth in the shutdown cycle. In an embodiment of the present invention, an initial crack size is entered in the data box 504. The final crack size at the end of the shutdown cycle, based on the shutdown profile 502, may be obtained in the data box 506. In an embodiment of the present invention, data boxes 508 and 510 are provided for entering one or more constants which are specific to the material property of the generator rotor 100. The data box 512 contains the time frame over which the shutdown may have been discretized. In an embodiment of the present invention, Paris's Law for fatigue crack growth may be used to compute the final crack size for the generator rotor 100.

In an embodiment of the present invention, the user interface 500 may further use the tabulated data of stress intensity factor range (ΔK), as shown in FIG. 4, to compute the final crack size. The table shown in FIG. 4 may be computed separately for the generator rotor 100 and may be stored in the database. The fretting fatigue model may retrieve the appropriate value of the stress intensity factor range (ΔK) from the database based on the rotational speed of the generator rotor 100 and the initial crack size.

In an embodiment of the present invention, the user interface 500 computes the final crack size based on the initial crack size, material properties of the generator rotor 100 and the shutdown profile 502. The final crack size for one shutdown cycle is taken as the initial crack size for the next shutdown cycle. The process may be repeated to get the crack size at the end of successive shutdown cycles. At each repetition the process uses the appropriate value of the stress intensity factor range (ΔK) from the table 400, depending on the initial crack size and rotational speed of the generator rotor 100, and shutdown profile 502. The plot 300 shown in FIG. 3 may be obtained, once the crack size at the end of successive shutdown cycles is obtained.

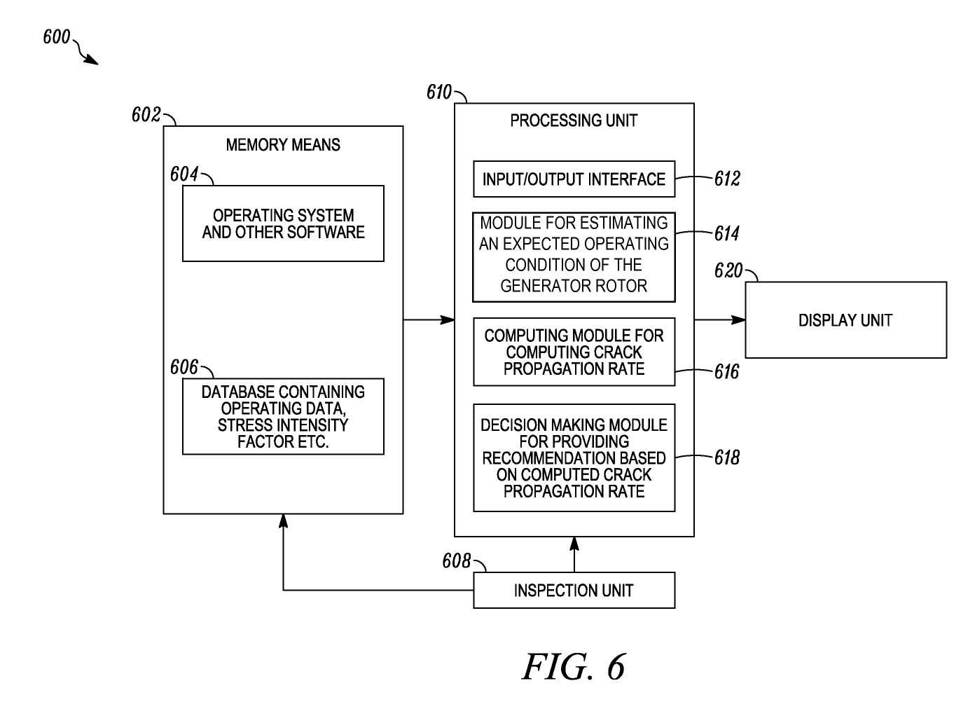

FIG. 6 illustrates a system 600 for providing one or more recommendations based on an assessment of the generator rotor, according to an embodiment of the present invention. The system 600 may include a computer readable memory means 602 which may act as a storage medium. The computer readable memory means 602 may be a Random Access Memory (RAM), Read Only Memory (ROM), flash memory or any suitable storing equipment. The computer readable memory means 602 may include a module 604 for storing operating system and other software. The operating system stored in module 604 is a set of computer executable instructions for controlling the overall operations of the system 600.

The module 604 may further consist of other software for effective operation of the system 600. Other software may include a computer program for performing steps of method 200. For example the computer program may include computer readable instructions for receiving results from an inspection, determining relevant parameters as described in step 210 of method 200, computing the crack propagation rate as described in step 220 of method 200 and making one or more recommendations pertaining to the maintenance of the generator rotor 100.

The computer readable memory means 602 may further include a module 606 storing a database of parameters required for computing crack propagation rate. The parameters may include the design parameters of the generator rotor 100, shutdown profile of the generator rotor 100, operating conditions of the generator rotor 100, material properties of the generator rotor 100, and geometries of the generator rotor 100. Operating conditions may include the rotational speeds of the generator rotor 100 and the power output of the generator. Operating conditions of the generator rotor 100 may also include the current operating condition or an expected operating condition of the generator rotor 100. In an embodiment of the present invention, the module 606 may store tabulated data of the stress intensity factor range (ΔK) as shown in FIG. 4. The stress intensity factor range (ΔK) data may either be computed on a real time basis or may be pre-computed.

The module 606 may further store the crack data obtained by the inspection unit 608. The inspection unit 608 is operable to inspect the generator rotor 100 for locating the crack and obtaining crack size. Inspection techniques for determining cracks and obtaining crack size are well known in the art. In one embodiment of the present invention, an ultrasonic inspection technique may be used. In an alternate embodiment, optical inspection techniques may be used. In an embodiment of the present invention, the inspection unit communicates the crack data to the computer readable memory means 602. The computer readable memory means 602 may store the crack data obtained from the inspection unit 608. In an alternate embodiment of the present invention, the crack data may be directly fed to a processing unit 610.

The processing unit 610 performs all the computations required for implementing method 200. The processing unit may include an input/output (I/O) interface 612. The I/O interface 612 is operable for getting data stored in module 606, and computer program instructions stored in module 604 of the computer readable memory means 602. In an embodiment of the present invention, the I/O interface 612 is a user interface for obtaining crack data, similar to the user interface 500. In an embodiment of the present invention, the processing unit 610 may obtain the crack data from the computer readable memory means 602 through the I/O interface 612. In an alternate embodiment of the present invention, the I/O interface 612 may directly obtain the crack data from the inspection unit 608.

The processing unit 610 may also include a module 614 for the computation of parameters relevant to the computation of crack propagation rate. Such parameters include the operating conditions, and the design parameters of the generator rotor. In an embodiment of the present invention, the module 614 may estimate the expected operating conditions of the generator rotor 100.

A crack propagation rate computation module 616 may be included in the processing unit 610. Based on the parameters computed in the module 614, the computation module 616 computes the crack propagation rate of a crack of the generator rotor 100. In an embodiment of the present invention, the crack propagation rate is computed based on the crack data, operating conditions of the generator rotor 100 and design parameters of the generator rotor 100. In a more specific embodiment of the present invention, the module 616 computes the crack propagation rate based on parameters including the stress intensity factor range (ΔK) for the inspected crack, the shutdown profile of the generator rotor 100, material properties of the generator rotor 100, and the operating history of the generator rotor 100. In another specific embodiment of the present invention, the computation module 616 may use the physics based life assessment technique to compute the crack propagation rate.

The system 600 may further consist of a decision making module 618. The module 618 may recommend at least one maintenance action based on the crack propagation rate. In an embodiment of the present invention, the module 618 may recommend repairing or replacement of the generator rotor 100. The system 600 further consists of a display unit 620 for displaying the recommendations to an operator. The display unit 620 may also display the residual life of the generator rotor 100 based on the inspected crack size and computed crack propagation rate.

In various embodiments, the module 614, computing module 616 and decision making module 618 may be implemented as non-transitory computer program code stored in a suitable computer readable medium. In some embodiments, the computer program code may be stored in a RAM or a ROM of the processing unit 610. In some other embodiments, the computer program code may be stored in memory means 602.

Although embodiments of the present invention have been described with reference to specific hardware and software components, those skilled in the art will appreciate that different combinations of hardware and/or software components may also be used, and that particular operations described as being implemented in hardware might also be implemented in software or vice versa. Other embodiments will be evident to those of ordinary skill in the art.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method for assessment of a generator rotor, the method comprising:
receiving crack data for the generator rotor from at least one inspection;
computing a crack propagation rate based on the crack data and at least one parameter, wherein the at least one parameter comprises an operating condition of the generator rotor or a design parameter of the generator rotor; and
providing at least one recommendation associated with the generator rotor based on the computed crack propagation rate.

2. The method of claim 1, wherein the operating condition comprises at least one of a current operating condition of the generator rotor or an expected operating condition of the generator rotor.

3. The method of claim 1, wherein the at least one parameter comprises at least one of a stress intensity factor range, a shutdown profile of the generator rotor, a material property of the generator rotor, a geometry of the generator rotor, and an operating history of the generator rotor.

4. The method of claim 1, wherein computing the crack propagation rate comprises a physics based life assessment technique that accounts for at least one of structural loads, boundary conditions, material properties, and mechanics of crack growth in a generator rotor in which small cracks have been observed.

5. The method of claim 1, wherein providing the at least one recommendation comprises at least one of:
recommending time intervals for the generator rotor inspection;
recommending an allowable number of start-ups for the generator rotor for a given timeframe; and
recommending repair requirements for the generator rotor.

6. A system for assessment of a generator rotor, the system comprising:
a user interface to provide crack data for the generator rotor for which crack propagation analysis is to be done;
a module for estimating an operating condition of the generator rotor;
a computing module operable to compute a crack propagation rate based on the crack data and at least one parameter, wherein the at least one parameter comprises the operating condition of the generator rotor or a design parameter of the generator rotor; and
a decision making module operable to provide at least one recommendation associated with the generator rotor based on the computed crack propagation rate.

7. The system of claim 6 further comprises a computer readable storage medium for storing at least one design parameter and at least one operating condition parameter.

8. The system of claim 6, wherein the at least one parameter comprises one or more of a stress intensity factor range, a shutdown profile of the generator rotor, a material property of the generator rotor, a geometry of the generator rotor, and an operating history of the generator rotor.

9. The system of claim 6, wherein the computing module is operable to compute the crack propagation rate based on a physics based life assessment technique that accounts for at least one of structural loads, boundary conditions, material properties, and mechanics of crack growth in a generator rotor in which small cracks have been observed.

10. The system of claim 6, wherein the user interface is operable to provide a crack size on a dovetail of the generator rotor to the computing module.

11. The system of claim 6, wherein the decision making module is operable to provide the at least one recommendations that comprise at least one of:
recommending time intervals for the generator rotor inspection;
recommending an allowable number of start-ups for the generator rotor for a given timeframe; and
recommending repair requirements for the generator rotor.

12. A computer program code stored in a computer readable storage medium, wherein the computer program code, when executed, is operative to cause one or more processors to:
receive crack data for a generator rotor from at least one inspection;
compute a crack propagation rate based on the crack data and at least one parameter, wherein the at least one parameter comprises an operating condition of the generator rotor or a design parameter of the generator rotor; and
provide at least one recommendation associated with the generator rotor based on the computed crack propagation rate;
wherein the computer program code comprises non-transitory code.

13. The computer program code of claim 12 further operative to cause the one or more processors to recommend performance of at least one inspection for providing the crack data for the generator rotor.

14. The computer program code of claim 12, wherein the recommendations may include at least one of:
recommending time intervals for the generator rotor inspection;
recommending an allowable number of start-ups for the generator rotor for a given timeframe; and
recommending repair requirements for the generator rotor.
